(19) United States
(12) Patent Application Publication
(10) Pub. No.: US 2005/0224164 A1
(43) Pub. Date: Oct. 13, 2005

(54) Method for making a composite board and the composite board made thereby

(76) Inventor: Jin-Fa Chu, Taipei City (TW)

Correspondence Address: FROMMER LAWRENCE & HAUG, 745 FIFTH AVENUE- 10TH FL., NEW YORK, NY, 10151, US

(21) Appl. No.: 10/823,335

(22) Filed: Apr. 13, 2004

(51) Int. Cl. B32B 31/00; B32B 5/00; B32B 7/00

(52) U.S. Cl. 156/230; 156/280; 156/306.6; 428/156; 428/98

(57) ABSTRACT

A method for making a composite board includes the steps of: providing a forming panel; applying a layer of releasing agent on the panel; providing a coating layer on the layer of releasing agent; providing a fiber layer on the coating layer; applying a layer of a binder to the fiber layer, and causing the binder to penetrate the fiber layer; placing a reinforcing structure on the layer of the binder to obtain a semi-product; removing the semi-product; and covering the reinforcing structure with a plastic plate. The composite board includes a reinforcing structure having first and second sides opposite to each other, and two face panels covering respectively the, first and second sides. Each of the face panels includes a binder layer proximate to the reinforcing structure, a fiber layer embedded in the binder layer, and a coating layer covering the fiber layer and the binder layer.

### BACKGROUND OF THE INVENTION

1. Field of the Invention

The invention relates to a method for making a composite board and the composite board made thereby, more particularly to a method for making a composite board and the composite board made thereby, which reduces production costs, and which is easy and convenient to use.

2. Description of the Related Art

Referring to FIG. 1, a conventional partition board 1 is usually made by using plastic, wood, or fiber as a main material. A conventional method for making the partition board 1 usually includes the steps of: preparing two outer panels 11, an inner board 12, and a frame 13 separately, mounting the inner board 12 within the frame 13, and fastening the inner board 12 and the frame 13 between the outer panels 11 by using a binder, screws, or nails.

However, the aforesaid partition board 1 has the following shortcomings:

1) Since a relatively large size is-required for the outer panels 11, it is necessary to use relatively thick outer panels 11 for the conventional partition board 1 so as to avoid bending or cracking of the outer panels 11.

2) Since the outer panels 11, the inner board 12, and the frame 13 are assembled to make the partition board 1 at a work site, the outer panels 11 are liable to get stained or to get scratched.

3) Since the conventional partition board 1 is assembled at the work site, a further finishing process is required for the conventional partition board 1. Therefore, it is relatively time-consuming to use the conventional partition board 1.

### SUMMARY OF THE INVENTION

Therefore, the object of the present invention is to provide a method for making a composite board and the composite board made thereby, which reduces production cost, and which is easy and convenient to use.

In one aspect of this invention, the method for making a composite board includes the steps of:
a) providing a forming panel;
b) applying a layer of releasing agent on the forming panel;
c) providing a coating layer on the layer of releasing agent;
d) providing a fiber layer on the coating layer;
e) applying a layer of a binder to the fiber layer, and causing the binder to penetrate the fiber layer;
f) placing a reinforcing structure on the layer of the binder before the binder is hardened so as to obtain a semi-product;
g) removing the semi-product from the forming panel; and
h) covering the reinforcing structure with a plastic plate.

In another aspect of this invention, the composite board includes:
a reinforcing structure having a first side and a second side opposite to said first side; and
two face panels covering respectively the first and second sides, each of the face panels including:
   a binder layer proximate to the reinforcing structure;
   a fiber layer embedded in the binder layer; and
   a coating layer covering the fiber layer and the binder layer.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional partition board;

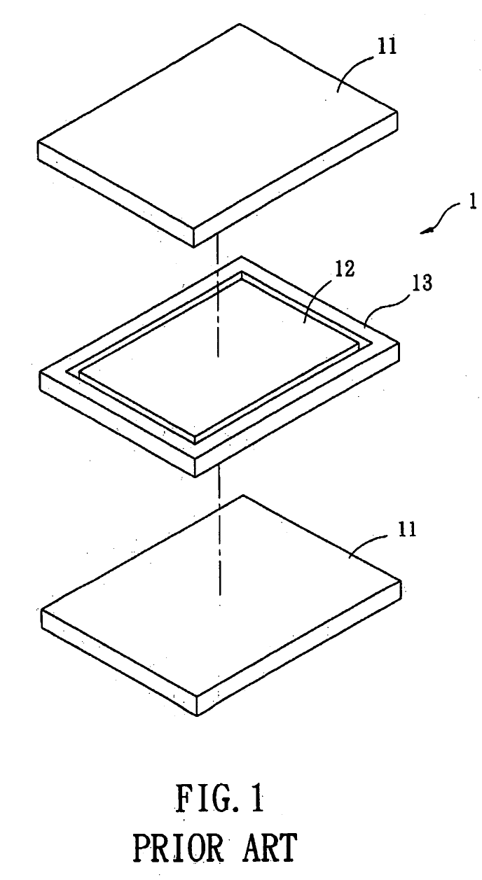

FIG. 2 is a flow diagram showing consecutive steps of a first preferred embodiment of a method for making a composite board according to this invention;

FIG. 3 is an exploded perspective view illustrating the first preferred embodiment;

FIG. 4 is an exploded perspective view of the composite board made by the first preferred embodiment;

FIG. 5 is a sectional view of the composite board of FIG. 4;

FIG. 6 is a flow diagram showing consecutive steps of a second preferred embodiment of a method for making a composite board according to this invention;

FIG. 7 is an exploded perspective view illustrating the second preferred embodiment; and

FIG. 8 is a perspective view of the composite board made by the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

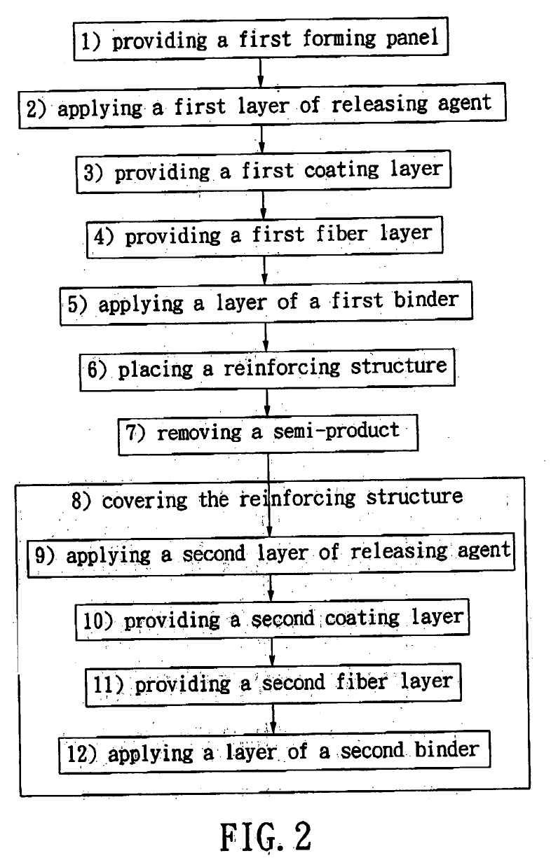

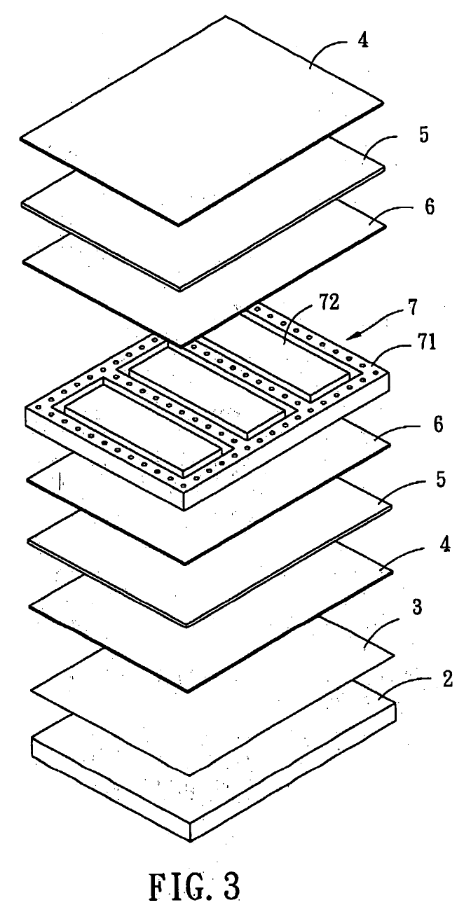

Referring to FIGS. 2 and 3, the first preferred embodiment of the method for making a composite board according to this invention includes the steps of:

1) providing a first forming panel 22
The forming panel 2 is optionally formed with a textured pattern so as to provide the composite board with a stereo pattern.

2) applying a first layer of releasing agent 3:
The first layer of releasing agent 3 is applied on the first forming panel 2.

3) providing a first coating layer 4:
The first coating layer 4 is provided on the first layer of releasing agent 3. The coating layer 4 includes a resin and a curing agent. Optionally, the coating layer 4 can further include a colorant, if desired, so as to change the color appearance of the composite board.

4) providing a first fiber layer 5:
The first fiber layer 5 is provided on the first coating layer 4. The first fiber layer 5 includes a glass fiber, which has characteristics, such as acid resistance, base resistance, fire resistance, fast dryness, and impact resistance.

5) applying a layer of a first binder 6:
A layer of the first binder 6 is applied to the first fiber layer 5, and the first binder 6 is caused to penetrate the first fiber layer 5. The first binder 6 includes a curing agent so as to cure the first binder 6 after a period of time.

6) placing a reinforcing structure 7:
The reinforcing structure 7 is placed on the layer of the first binder 6 before the first binder 6 is hardened so as to obtain a semi-product. In the first preferred embodiment, the reinforcing structure 7 includes a frame portion 71 and an inner portion 72 surrounded by the frame portion 71, and is used for reinforcing the overall strength of the composite board and for enhanced effects, such as fire resistance, sound insulation, and heat insulation. The materials for the frame portion 71 and the inner portion 72 depend on the intended use of the composite board.

7) removing the semi product:
The semi-product including the first coating layer 4, the first fiber layer 5, the layer of the first binder 6, and the reinforcing structure 7 is removed from the first forming panel 2.

8) covering the reinforcing structure 7:
The reinforcing structure 7 of the semi-product is covered with a plastic plate so as to obtain the composite board. In this preferred embodiment, the plastic plate is formed by the steps of:

9) applying a second layer of releasing agent 3:
The second layer of releasing agent 3 is applied on a second forming panel 2.

10) providing a second coating layer 4:
The second coating layer 4 is provided on the second layer of the releasing agent 3. Similarly, the coating layer 4 includes a resin and a curing agent. Optionally, the coating layer 4 can further include a colorant, if desired.

11) providing a second fiber layer 5:
The second fiber layer 5 is provided on the second coating layer 4. Similarly, the second fiber layer 5 includes a glass fiber.

12) applying a layer of a second binder 6:
The layer of the second binder 6 is applied to the second fiber layer 5, and the second binder 6 is caused to penetrate the second fiber layer 5. Similarly, the second binder 6 includes a curing agent. Thereafter, the semi-product is laid on the layer of the second binder 6 before the second binder 6 is hardened by placing the reinforcing structure 7 of the semi-product in contact with the layer of the second binder 6.

It is noted that, in the preferred embodiment, each of the coating layers 4, the fiber layers 5, and the layers of the binder 6 is illustrated as a single layer. However, in practice, each of the coating layers 4, the fiber layers 5, and the layers of the binder 6 can be a laminated layer, or the coating layers 4, the fiber layers 5, and the layers of the binder 6 can be laminated alternately and repeatedly.

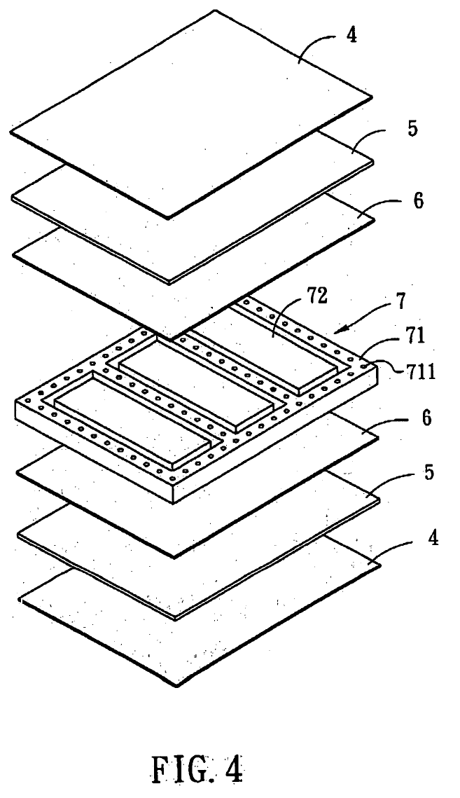

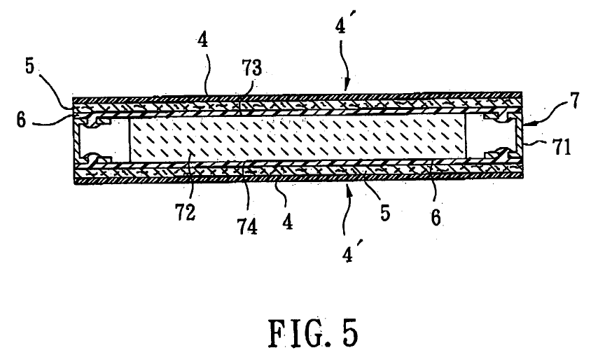

Referring to FIGS. 4 and 5, the composite-board made in the first preferred embodiment is shown to include a reinforcing structure 7 having a first side 73 and a second side 74 opposite to the first side 73; and two face panels 4′ covering respectively the first and second sides 73, 74. Each of the face panels 4′ includes a binder layer 6 proximate to the reinforcing structure 7, a fiber layer 5 embedded in the binder layer 6, and a coating layer 4 covering the fiber layer 5 and the binder layer. The reinforcing structure 7 is a rigid body, which has holes 711 for the binder 6 to enter thereinto. The, frame portion 71 of the reinforcing structure 7 is made of a material selected from a group consisting of wood, steel, and plastic. The inner portion 72 of the reinforcing structure 7 is made of a material selected from a group consisting of a foam board and a honeycomb board.

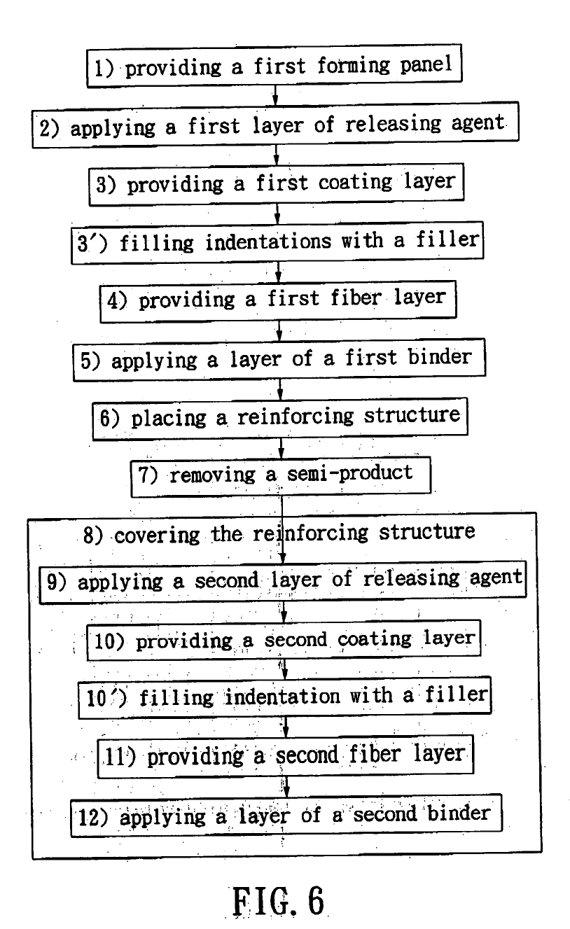

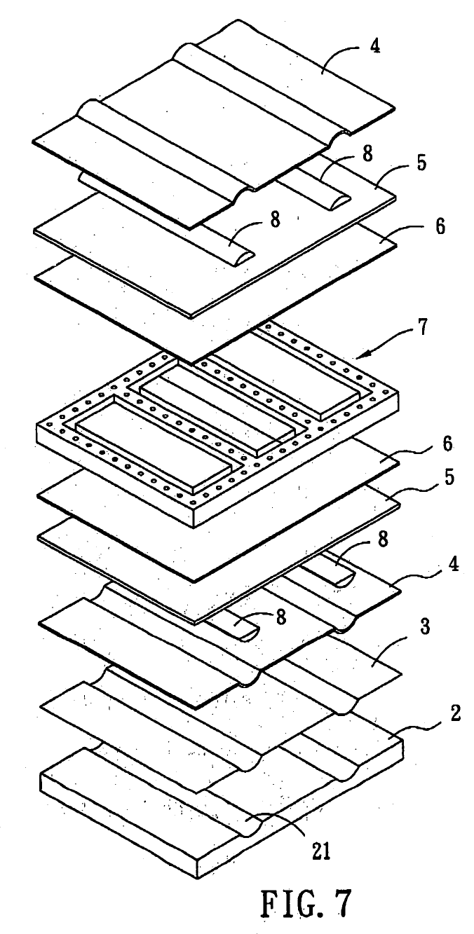

Referring to FIGS. 6 and 7, the second preferred embodiment of the invention is substantially identical to the first preferred embodiment, except for the following:

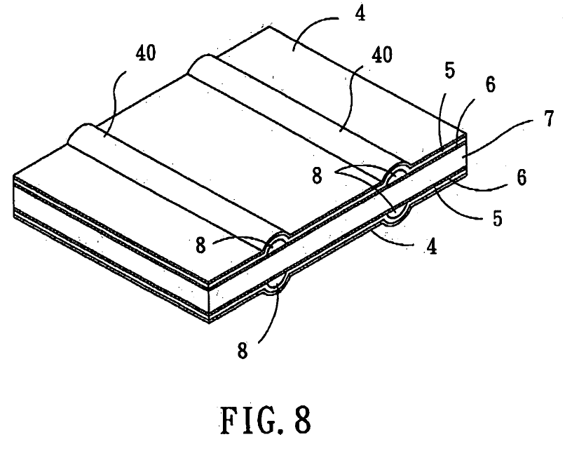

The first forming panel 2 has two indentations 21 to form a raised pattern 40 (see FIG. 8). The method further includes a step of filling the indentations 21 with a filler 8 before step 4). Furthermore, the second forming panel 2 also has two indentation 21 to form another raised pattern 40. The method further includes a step of filling the indentations 21 of the second forming panel 2 with a filler before step 11).

Referring to FIG. 8, the composite board made in the second preferred embodiment of this invention is substantially identical to that of the first preferred embodiment. However, the composite board of the second preferred embodiment further includes fillers 8 that form the composite board with the raised patterns 40.

In view of the aforesaid, the method for making a composite board according to this invention and the composite board made thereby can overcome the aforesaid shortcomings of the prior art so as to increase the production yield, improve the product quality, permit flexibility in product design, enhance convenience during use of the product, and reduce the production costs.

While the present invention has been described in connection with what is considered the most practical and preferred embodiments, it is understood that this invention is not limited to,the disclosed embodiments but is intended to cover various arrangements included within the spirit and, scope of the broadest interpretation so as to encompass all such modifications and equivalent arrangements.

1. A method for making a composite board, comprising the steps of:
a) providing a first forming panel;
b) applying a first layer of releasing agent on said first forming panel;
c) providing a first coating layer on said first layer of releasing agent;
d) providing a first fiber layer on said first coating layer;
e) applying a layer of a first binder to said first fiber layer and causing said first binder to penetrate said first fiber layer;
f) placing a reinforcing structure on said layer of said first binder before said first binder is hardened so as to obtain a semi-product;
g) removing said semi-product from said first forming panel; and
h) covering said reinforcing structure with a plastic plate.

2. The method as claimed in claim 1, wherein said plastic plate is formed by the steps of:
i) applying a second layer of releasing agent on a second forming panel;
j) providing a second coating layer on said second layer of releasing agent;
k) providing a second fiber layer on said second coating layer; and
l) applying a layer of a second binder to said second fiber layer, and causing said second binder to penetrate said second fiber layer.

3. The method as claimed in claim 2, wherein said semi-product is laid on said layer of said second binder before said second binder is hardened by placing said reinforcing structure in contact with said layer of said second binder.

4. The method as claimed in claim 2, wherein each of said first and second coating layers includes a resin and a curing agent.

5. The method as claimed in claim 2, wherein each of said first and second fiber layers includes a glass fiber.

6. The method as claimed in claim 2, wherein each of said layer of said first binder and said layer of said second binder includes a curing agent.

7. The method as claimed in claim 1, wherein said reinforcing structure includes a frame portion and an inner portion surrounded by said frame portion.

8. The method as claimed in claim 1, wherein said reinforcing structure is a rigid body which has holes for said first binder to enter thereinto during step f).

9. The method as claimed in claim 7, wherein said frame portion is made of a material selected from a group consisting of wood, steel, and plastic.

10. The method as claimed in claim 7, wherein said inner portion is made of a material selected from a group consisting of a foam board and a honeycomb board.

11. The method as claimed in claim 1, wherein said first forming panel has an indentation to form a raised pattern, said method further including a step of filling said indentation with a filler before step d).

12. The method as claimed in claim 2, wherein said second forming panel has an indentation to form a raised pattern, said method further including a step of filling said indentation with a filler before step k).

13. A composite board, comprising:
a reinforcing structure having a first side and a second side opposite to said first side; and
two face panels covering respectively said first and second sides, each of said face panels including:
a binder layer proximate to said reinforcing structure;
a fiber layer embedded in said binder layer; and
a coating layer covering said fiber layer and said binder layer.

14. The composite board as claimed in claim 13, wherein each of said face panels further includes at least one raised pattern projecting outward from a surface thereof.

15. The composite board as claimed in claim 13, wherein said fiber layer includes a glass fiber.

16. The composite board as claimed in claim 13, wherein said binder layer includes a curing agent.

17. The composite board as claimed in claim 13, wherein said reinforcing structure is a rigid body which has holes for a portion of said binder layer to enter thereinto.

18. The composite board as claimed in claim 13, wherein said reinforcing structure includes a frame portion and an inner portion surrounded by said frame portion.

19. The composite board as claimed in claim 18, wherein said frame portion is made of a material selected from a group consisting of wood, steel, and plastic.

20. The composite board as claimed in claim 18, wherein said inner portion is made of a material selected from a group consisting of a foam board and a honeycomb board.
